(19) United States
(12) Patent Application Publication
(10) Pub. No.: US 2021/0357726 A1
(43) Pub. Date: Nov. 18, 2021

(54) FUSION STRUCTURE AND METHOD OF CONVOLUTIONAL NEURAL NETWORK AND SPIKING NEURAL NETWORK

(71) Applicant: TSINGHUA UNIVERSITY, Beijing (CN)

(72) Inventors: Zhaolin LI, Beijing (CN); Mingyu WANG, Beijing (CN)

(21) Appl. No.: 17/386,570

(22) Filed: Jul. 28, 2021

Related U.S. Application Data
(63) Continuation of application No. PCT/CN2019/117039, filed on Nov. 11, 2019.

(30) Foreign Application Priority Data
Jan. 29, 2019 (CN) 201910087183.8

(51) Int. Cl. G06N 3/04; G06N 3/08

(52) U.S. Cl. CPC G06N 3/049; G06N 3/08; G06N 3/0454

(57) ABSTRACT

A fusion structure (10) and method of a convolutional neural network and a spiking neural network are provided. The structure includes a convolutional neural network structure (100), a spiking converting and encoding structure (200), and a spiking neural network structure (300). The convolutional neural network structure (100) includes an input layer, a convolutional layer, and a pooling layer. The spiking converting and encoding structure (200) includes a spiking converting neuron and a configurable spiking encoder. The spiking neural network structure (300) includes a spiking convolutional layer, a spiking pooling layer, and a spiking output layer.

### CROSS-REFERENCES TO RELATED APPLICATIONS

The present application is a continuation of International Application No. PCT/CN2019/117039, filed on Nov. 11, 2019, which claims priority to Chinese Patent Application No. 201910087183.8, titled “FUSION STRUCTURE AND METHOD OF CONVOLUTIONAL NEURAL NETWORK AND SPIKING NEURAL NETWORK” and filed by Tsinghua University on Jan. 29, 2019, the entire disclosures of which are hereby incorporated herein by reference.

### TECHNICAL FIELD

The present disclosure relates to the field of high-speed image recognition technologies, and more particularly, to a fusion structure and method of a convolutional neural network and a spiking neural network.

### BACKGROUND

In the field of image recognition, the convolutional neural network is currently widely used for image classification and recognition, and the convolutional neural network already has relatively mature network structures and training algorithms. Existing research results show that if the quality of training samples is guaranteed and the training samples sufficient, the convolutional neural network has a high recognition accuracy in conventional image recognition. However, the convolutional neural network also has certain shortcomings. With the increasingly complexity of sample features, the structure of the convolutional neural network has become more and more complex, and network hierarchies are also increasing, thereby resulting in a sharp increase in the amount of calculation to complete network training and derivation, and prolonging the delay of network calculation.

Therefore, in the field of high-speed image recognition, especially for some real-time embedded systems, it is difficult for the convolutional neural network to meet computational delay requirements of these systems. On the other hand, the spiking neural network is a new type of neural network that uses discrete neural spiking for information processing. Compared with conventional artificial neural networks, the spiking neural network has better biological simulation performance, and thus is one of the research hot spots in recent years. The discrete spiking of the spiking neural network has a sparse feature, such that the spiking neural network can greatly reduce the amount of network operations, and has advantages in achieving high performance, achieving low power consumption and alleviating overfitting. Therefore, it is necessary to implement a fused network of the convolutional neural network and the spiking neural network. This fused network can not only exert advantages of the convolutional neural network in ensuring the image recognition accuracy, but also give play to advantages of the spiking neural network in terms of low power consumption and low delay, so as to achieve feature extraction and accurate classification of high-speed time-varying information.

### SUMMARY

The present disclosure aims to solve at least one of the technical problems in the related art to a certain extent.

To this end, an object of the present disclosure is to provide a fusion structure of a convolutional neural network and a spiking neural network, capable of simultaneously taking into account advantages of the convolutional neural network and the spiking neural network, i.e., taking an advantage of a high recognition accuracy of the convolutional neural network in the field of image recognition, and giving play to an advantage of the spiking neural network in aspects of sparsity, low power consumption, overfitting alleviation, and the like, such that the structure can be applied to fields of feature extraction, accurate classification, and the like of high-speed time-varying information.

Another object of the present disclosure is to provide a fusion method of a convolutional neural network and a spiking neural network.

In order to achieve the above objects, in an aspect, an embodiment of the present disclosure provides a fusion structure of a convolutional neural network and a spiking neural network, including: a convolutional neural network structure including an input layer, a convolutional layer and a pooling layer, wherein the input layer is configured to receive pixel-level image data, the convolutional layer is configured to perform a convolution operation, and the pooling layer is configured to perform a pooling operation; a spiking converting and encoding structure including a spiking converting neuron and a configurable spiking encoder, wherein the spiking converting neuron is configured to convert the pixel-level image data into spiking information based on a preset encoding form, and the configurable spiking encoder is configured to set the spiking converting and encoding structure into time encoding or frequency encoding; and a spiking neural network structure including a spiking convolutional layer, a spiking pooling layer, and a spiking output layer, wherein the spiking convolutional layer and the spiking pooling layer are respectively configured to perform a spiking convolution operation and a spiking pooling operation on the spiking information to obtain an operation result, and the spiking output layer is configured to output the operation result.

With the fusion structure of the convolutional neural network and the spiking neural network according to an embodiment of the present disclosure, the structure of a fused network is clear and a training algorithm of the fused network is simple. The fused network can not only exert advantages of the convolutional neural network in ensuring the image recognition accuracy, but also give play to advantages of the spiking neural network in terms of low power consumption and low delay. The fusion structure is tailorable and universal, with a simple implementation and moderate costs. In addition, the fusion structure can be quickly deployed to different practical engineering applications. In any related engineering projects that need to achieve high-speed image recognition, feature extraction and accurate classification of the high-speed time-varying information can be implemented through designing the fused network.

In addition, the fusion structure of the convolutional neural network and the spiking neural network according to an embodiment of the present disclosure may also have the following additional technical features.

Further, in an embodiment of the present disclosure, the spiking converting neuron is further configured to map the pixel-level image data into an analog current in accordance with a conversion of a spiking firing rate and obtain the spiking information based on the analog current.

Further, in an embodiment of the present disclosure, a corresponding relation between the spiking firing rate and the analog current is:

$$Rate = \frac{1}{{t}_{ref} - {τ}_{RC} ln ( \frac{V ( {t}_{1} ) - I}{V ( {t}_{0} ) - I} )} ,$$

where Rate represents the spiking firing rate, t_{ref} represents a length of a neural refractory period, τ_{RC} represents a time constant determined based on a membrane resistance and a membrane capacitance, V(t₀) and V(t₁) represent membrane voltages at t₀ and t₁, respectively, and l represents the analog current.

Further, in an embodiment of the present disclosure, the spiking convolution operation further includes: a pixel-level convolutional kernel generating a spiking convolutional kernel in accordance with mapping relations of a synaptic strength and a synaptic delay of a neuron based on an LIF (Leaky-Integrate-and-Fire) model, and generating a spiking convolution feature map in accordance with the spiking convolutional kernel and the spiking information through a spiking multiplication and addition operation.

Further, in an embodiment of the present disclosure, the spiking pooling operation further includes: a pixel-level pooling window generating a spiking pooling window based on the mapping relations of the synaptic strength and the synaptic delay, and generating a spiking pooling feature map in accordance with the spiking pooling window and the spiking information through a spiking accumulation operation.

Further, in an embodiment of the present disclosure, the mapping relations of the synaptic strength and the synaptic delay further include: the pixel-level convolutional kernel and the pixel-level pooling window mapping a weight and a bias of an artificial neuron based on an MP (McCulloch-Pitts) model to the synaptic strength and the synaptic delay of the neuron based on the LIF model, respectively.

Further, in an embodiment of the present disclosure, the mapping relations of the synaptic strength and the synaptic delay further include: the spiking information being superposed by adopting an analog current superposition principle, on a basis of mapping the weight and the bias of the artificial neuron based on the MP model to the synaptic strength and the synaptic delay of the neuron based on the LIF model, respectively.

Further, in an embodiment of the present disclosure, the spiking accumulation operation further includes: the pixel-level convolutional kernel mapping the weight and the bias of the artificial neuron based on the MP model to the synaptic strength and the synaptic delay of the neuron based on the LIF model.

In order to achieve the above objects, in another aspect, an embodiment of the present disclosure provides a fusion method of a convolutional neural network and a spiking neural network, which includes the following steps of: establishing a corresponding relation between an equivalent convolutional neural network and a fused neural network; and converting a learning and training result of the equivalent convolutional neural network and a learning and training result of a fused network of the convolutional neural network and the spiking neural network in accordance with the corresponding relation to obtain a fusion result of the convolutional neural network and the spiking neural network.

With the fusion method of the convolutional neural network and the spiking neural network according to an embodiment of the present disclosure, the structure of a fused network is clear and a training algorithm of the fused network is simple. The fused network can not only exert advantages of the convolutional neural network in ensuring the image recognition accuracy, but also give play to advantages of the spiking neural network in terms of low power consumption and low delay. The fusion structure is tailorable and universal, with a simple implementation and moderate costs. In addition, the fusion structure can be quickly deployed to different practical engineering applications. In any related engineering projects that need to achieve high-speed image recognition, feature extraction and accurate classification of the high-speed time-varying information can be implemented through designing the fused network.

In addition, the fusion method of the convolutional neural network and the spiking neural network according to an embodiment of the present disclosure may also have the following additional technical features.

Further, in an embodiment of the present disclosure, the corresponding relation between the equivalent convolutional neural network and the fused neural network includes a mapping relation between a network layer structure, a weight and a bias, and an activation function.

Additional aspects and advantages of the present disclosure will be given at least in part in the following description, or become apparent at least in part from the following description, or can be learned from practicing of the present disclosure.

### BRIEF DESCRIPTION OF FIGURES

The above and/or additional aspects and advantages of the present disclosure will become more apparent and more understandable from the following description of embodiments taken in conjunction with the accompanying drawings, in which:

FIG. 1 is a block diagram showing a structure of a fusion structure of a convolutional neural network and a spiking neural network according to an embodiment of the present disclosure;

FIG. 2 is a schematic diagram showing a fused network of a convolutional neural network and a spiking neural network according to an embodiment of the present disclosure;

FIG. 3 is a schematic diagram showing a hierarchical structure of a fused network of a convolutional neural network and a spiking neural network according to an embodiment of the present disclosure;

FIG. 4 is a flowchart illustrating a spiking convolution operation according to an embodiment of the present disclosure;

FIG. 5 is a flowchart illustrating a spiking pooling operation according to an embodiment of the present disclosure;

FIG. 6 is a flowchart illustrating a spiking multiplication and addition operation and a spiking accumulation operation according to an embodiment of the present disclosure;

FIG. 7 is a flowchart illustrating a learning and training method of a fused network according to an embodiment of the present disclosure; and

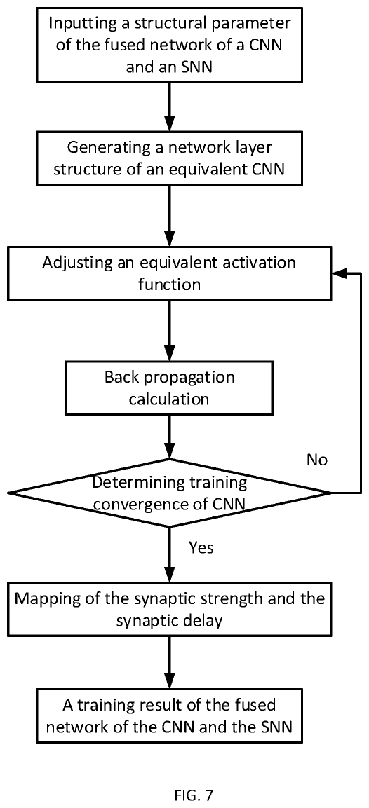

FIG. 8 is a flowchart of a fusion method of a convolutional neural network and a spiking neural network according to an embodiment of the present disclosure.

### DETAILED DESCRIPTION

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

A fusion structure and method of a convolutional neural network and a spiking neural network according to the embodiments of the present disclosure will be described below with reference to the figures. The fusion structure of the convolutional neural network and the spiking neural network according to an embodiment of the present disclosure will be described below first with reference to the figures.

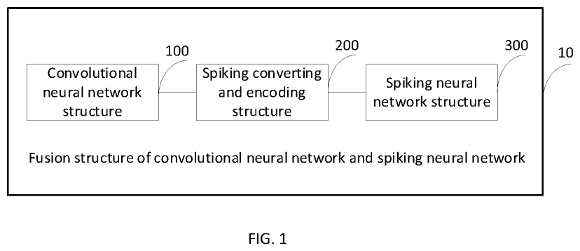

FIG. 1 is a block diagram showing a structure of a fusion structure of a convolutional neural network and a spiking neural network according to an embodiment of the present disclosure.

As illustrated in FIG. 1, a fusion structure 10 of a convolutional neural network and a spiking neural network includes a convolutional neural network structure 100, a spiking converting and encoding structure 200, and a spiking neural network structure 300.

The convolutional neural network structure 100 includes an input layer, a convolutional layer, and a pooling layer. The input layer is configured to receive pixel-level image data. The convolutional layer is configured to perform a convolution operation. The pooling layer is configured to perform a pooling operation. The spiking converting and encoding structure 200 includes a spiking converting neuron and a configurable spiking encoder. The spiking converting neuron is configured to convert the pixel-level image data into spiking information based on a preset encoding form. The configurable spiking encoder is configured to set the spiking converting and encoding structure into time encoding or frequency encoding. The spiking neural network structure 300 includes a spiking convolutional layer, a spiking pooling layer, and a spiking output layer. The spiking convolutional layer and the spiking pooling layer are respectively configured to perform a spiking convolution operation and a spiking pooling operation on the spiking information to obtain an operation result. The spiking output layer is configured to output the operation result. The structure 10 according to an embodiment of the present disclosure can simultaneously take into account advantages of the convolutional neural network and the spiking neural network, i.e., taking an advantage of a high recognition accuracy of the convolutional neural network in the field of image recognition, and giving play to an advantage of the spiking neural network in aspects of sparsity, low power consumption, overfitting alleviation, etc., such that the structure can be applied to fields of feature extraction, accurate classification, and the like of high-speed time-varying information.

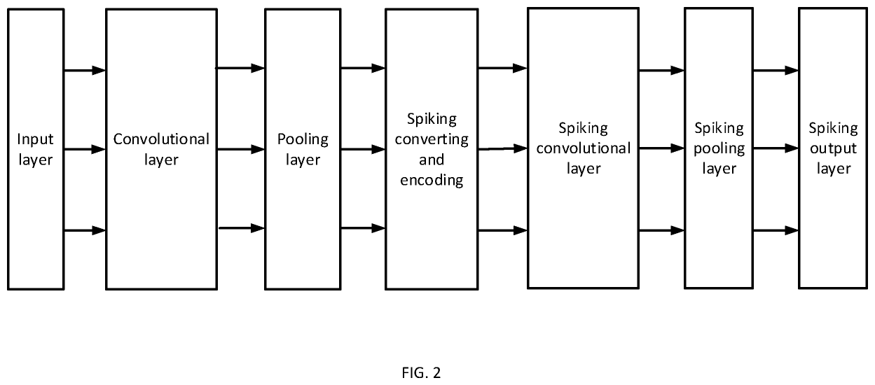

Specifically, as illustrated in FIG. 2, the fused network structure 10 of the convolutional neural network and the spiking neural network includes three parts, namely, a convolutional neural network structure part, a spiking neural network structure part, and a spiking converting and encoding part. The convolutional neural network structure part further includes an input layer, a convolutional layer and an output layer. The spiking neural network structure part further includes a spiking convolutional layer, a spiking layer and a spiking output layer.

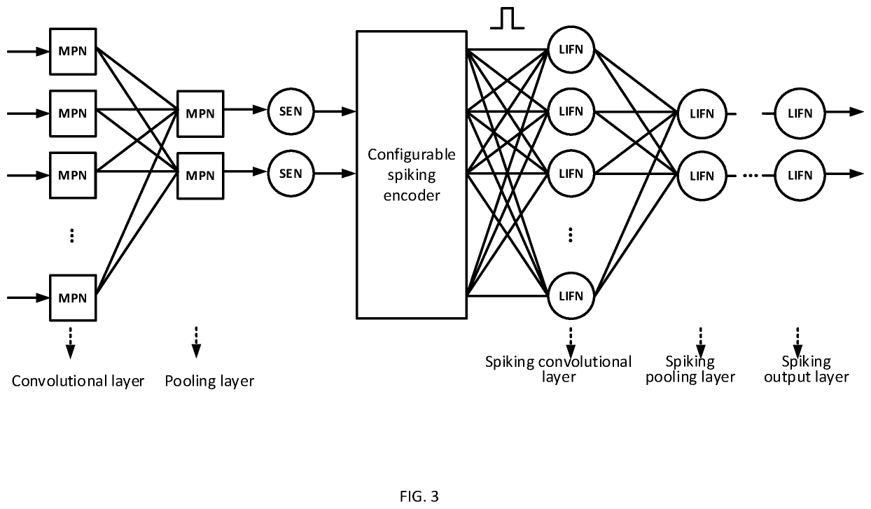

As illustrated in FIG. 3, the convolutional neural network structure part further includes the input layer, the convolutional layer and the pooling layer that are implemented by an artificial neuron (MPN) based on an MP model, which are respectively configured to receive an external pixel-level image data input, perform a convolution operation, and perform a pooling operation. The number of network layers that have completed the convolution operation or the pooling operation involved in the convolutional neural network structure part can be appropriately increased or deleted based on practical application tasks. It should be noted that the “MP model” represents the McCulloch-Pitts Model, which is a binary switch model that can be combined in different ways to complete various logic operations.

The spiking converting and encoding part further includes a spiking converting neuron (SEN) and a configurable spiking encoder, which can convert pixel-level data into spiking information based on a specific encoding form. That is, the spiking converting and encoding part involves a converting and encoding process of converting the pixel-level data into the spiking information. A level structure of this part is configurable, and can be configured as time encoding, frequency encoding or other new forms of encoding as needed.

The spiking neural network structure part further includes a spiking convolutional layer, a spiking pooling layer, and a spiking output layer that are implemented by a spiking neuron (LIFN) based on an LIF model. The number of network layers that have completed the convolution operation or the pooling operation involved in the spiking neural network structure part can be appropriately increased or deleted based on practical application tasks. The spiking convolutional layer and the spiking pooling layer further respectively include a spiking convolution operation and a spiking pooling operation, which are respectively configured to process the convolution operation and the pooling operation based on the spiking information after a conversion of the previous network level, and output a final result. It should be noted that the “LIF model”, represents the Leaky-Integrate-and-Fire model, which is a differential equation of neuron dynamics that describes a transfer relation of action potentials in neurons.

Further, in an embodiment of the present disclosure, the spiking converting neuron is further configured to map the pixel-level image data into an analog current in accordance with a conversion of a spiking firing rate, and obtain the spiking information based on the analog current.

It can be understood that the spiking converting neuron (SEN) and the configurable spiking encoder further include mapping pixel-level output data of the convolutional neural network to the analog current in accordance with a spiking firing rate conversion formula to implement a conversion of the pixel-level data into the spiking information based on the frequency encoding.

In an embodiment of the present disclosure, a corresponding relation between the spiking firing rate and the analog current is:

$$Rate = \frac{1}{{t}_{ref} - {τ}_{RC} ln ( \frac{V ( {t}_{1} ) - I}{V ( {t}_{0} ) - I} )} ,$$

where Rate represents the spiking firing rate, t_{ref} represents a length of a neural refractory period, τ_{RC} represents a time constant determined based on a membrane resistance and a membrane capacitance, V(t₀) and V(t₁) represent membrane voltages at t₀ and t₁, respectively, and l represents the analog current. It should be noted that the “membrane resistance, the “membrane capacitance” and the “membrane voltages”’ all refer to physical quantities used to represent biophysical characteristics of cell membranes in the LIF model, and describe a conduction relation of ion currents of neurons in synapses.

Specifically, the spiking converting and encoding part further includes a converting and encoding implementation method between the pixel-level data and the spiking information. For example, a corresponding relation between a spiking firing rate of the spiking neuron based on the LIF model and the analog current can be described by Formula 1:

$$Rate = \frac{1}{{t}_{ref} - {τ}_{RC} ln ( \frac{V ( {t}_{1} ) - I}{V ( {t}_{0} ) - I} )} , \qquad ( 1 )$$

where Rate represents the spiking firing rate, t_{ref} represents the length of the neural refractory period, τ_{RC} represents the time constant determined based on the membrane resistance and the membrane capacitance, V(t₀) and V(t₁) represent the membrane voltages at t₀ and t₁, respectively, and l represents the analog current. In particular, in a time interval from t₀ and t₁, when the membrane voltage rises from 0 to 1, Formula 1 can be simplified to Formula 2 as:

$$Rate = \frac{1}{{t}_{ref} - {τ}_{RC} ln ( 1 - 1 / I )} \qquad ( 2 )$$

According to Formula 1 or Formula 2, the pixel-level output data of the convolutional neural network can be mapped to the analog current, and then t_{ref} and the constant τ_{RC} can be adjusted appropriately based on practical needs, such that the pixel-level data can be converted into the spiking information based on the frequency encoding. Formula 1 and Formula 2 can also adopt other deformations or higher-order correction forms according to practical needs.

Further, in an embodiment of the present disclosure, the spiking convolution operation further includes: a pixel-level convolutional kernel generating a spiking convolutional kernel in accordance with mapping relations of a synaptic strength and a synaptic delay of a neuron based on an LIF model, and generating a spiking convolution feature map in accordance with the spiking convolutional kernel and the spiking information through a spiking multiplication and addition operation.

It can be understood that the spiking convolution operation further includes: the pixel-level convolutional kernel generating the spiking convolutional kernel in accordance with the mapping relations of the synaptic strength and the synaptic delay, and generating the spiking convolution feature map in accordance with the input spiking information and the mapped spiking convolutional kernel through the spiking multiplication and addition operation.

In an embodiment of the present disclosure, the mapping relations of the synaptic strength and the synaptic delay further include the pixel-level convolutional kernel and a pixel-level pooling window mapping a weight and a bias of an artificial neuron based on an MP model to the synaptic strength and the synaptic delay of the neuron based on the LIF model, respectively.

It can be understood that the mapping relations of the synaptic strength and the synaptic delay further include a method of the pixel-level convolutional kernel and the pooling window mapping the weight and the bias of the artificial neuron based on the MP model to the synaptic strength and the synaptic delay of the neuron based on the LIF model.

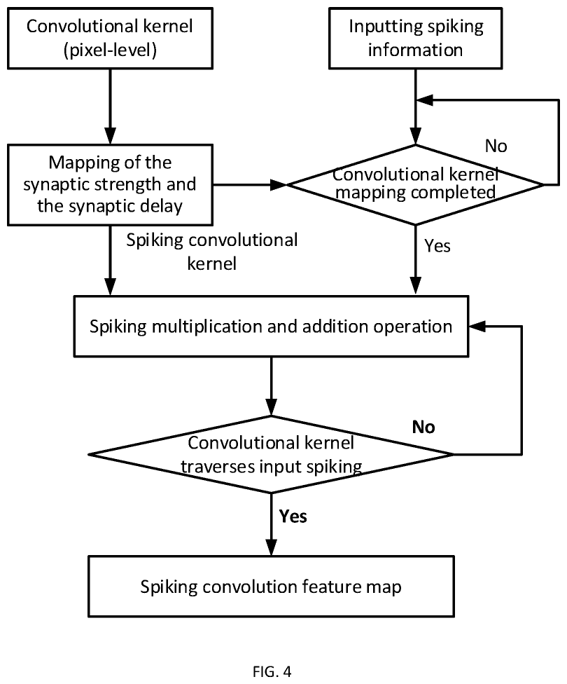

Specifically, as illustrated in FIG. 4, the pixel-level convolutional kernel is mapped to the synaptic strength and the synaptic delay based on a one-to-one correspondence, and then the spiking convolution feature map is generated in accordance with the input spiking information and the mapped spiking convolutional kernel through the spiking multiplication and addition operation. Specifically, the spiking convolution operation in the spiking neural network structure part further includes a method of implementing mapping and a replacement based on the corresponding relation established between the artificial neuron based on the MP model and the spiking neuron based on the LIF model during the convolution operation. The weight and the bias of the artificial neuron based on the MP model are respectively mapped to the synaptic strength and the synaptic delay of the neuron based on the LIF model.

Further, in an embodiment of the present disclosure, the spiking pooling operation further includes: the pixel-level pooling window generating a spiking pooling window based on the mapping relations of the synaptic strength and the synaptic delay, and generating a spiking pooling feature map in accordance with the spiking pooling window and the spiking information through a spiking accumulation operation.

It can be understood that the spiking pooling operation further includes: the pixel-level pooling window generating the spiking pooling window based on the mapping relations of the synaptic strength and the synaptic delay, and generating the spiking pooling feature map in accordance with the input spiking information and the mapped spiking pooling window through the spiking accumulation operation.

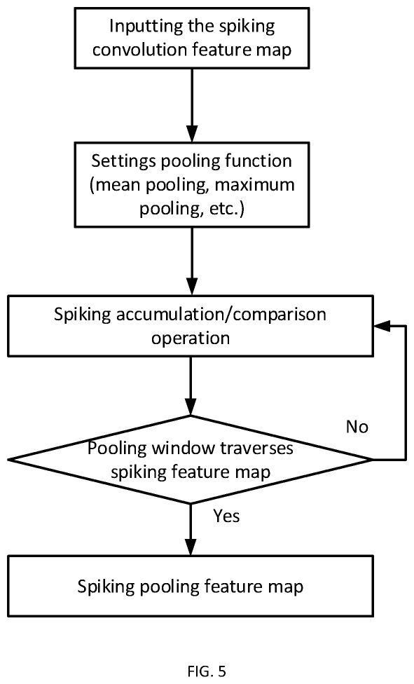

Specifically, as illustrated in FIG. 5, the spiking pooling operation in the spiking neural network structure part further includes a method of implementing mapping and a replacement based on the corresponding relation established between the artificial neuron based on the MP model and the spiking neuron based on the LIF model during the convolution operation. The weight and the bias of the artificial neuron based on the MP model are respectively mapped to the synaptic strength and the synaptic delay of the neuron based on the LIF model. The spiking convolution feature map, under control of a pooling function (mean pooling or maximum pooling, etc.), adjusts the pooling window to traverse the spiking convolution feature map. Finally, the spiking pooling feature map is output.

Further, in an embodiment of the present disclosure, the spiking accumulation operation further includes: the pixel-level convolutional kernel mapping the weight and the bias of the artificial neuron based on the MP model to the synaptic strength and the synaptic delay of the neuron based on the LIF model.

It can be understood that the spiking multiplication and addition operation further includes: the pixel-level convolutional kernel mapping the weight and the bias of the artificial neuron based on the MP model to the synaptic strength and the synaptic delay of the neuron based on the LIF model.

Further, in an embodiment of the present disclosure, the mapping relations of the synaptic strength and the synaptic delay further include: the spiking information being superposed by adopting an analog current superposition principle, on a basis of mapping the weight and the bias of the artificial neuron based on the MP model to the synaptic strength and the synaptic delay of the neuron based on the LIF model neuron, respectively.

It can be understood that the mapping relations of the synaptic strength and the synaptic delay further include a method of implementing superposition of the spiking information by adopting the analog current superposition principle, on the basis of mapping the weight and the bias of the artificial neuron based on the MP model to the synaptic strength and the synaptic delay of the neuron based on the LIF model neuron, respectively.

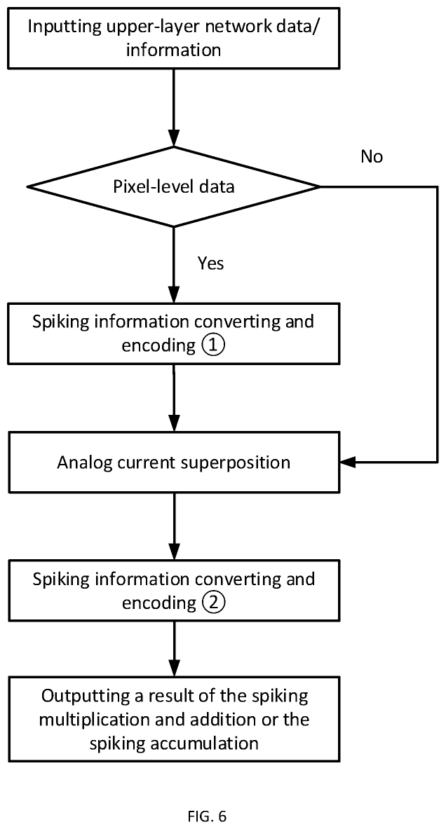

Specifically, as illustrated in FIG. 6, the spiking multiplication and addition operation and the spiking accumulation operation involved in the spiking convolution operation and the spiking pooling operation in the spiking neural network structure part further include a method of implementing the superposition of the spiking information based on superposition of the analog current. The superposition of the analog current can be described by Formula 3:

$$I ( t ) = {\sum }_{i} {S}_{i} \cdot I ( t - {d}_{i} ) \cdot Ψ ( t ) \qquad ( 3 )$$

In Formula 3, l(t) represents the analog current, Sᵢ and dᵢ represent the synaptic strength and the synaptic delay respectively, and Ψ(t) represents a correction function, which can be adjusted based on practical engineering needs.

Further, the spiking pooling operation involves the spiking multiplication and addition operation, the spiking accumulation operation, or a spiking comparison operation. spiking accumulation is a special form of spiking multiplication and addition (a weighting factor is 1). FIG. 6 illustrates more details of the spiking multiplication and addition operation. The spiking comparison operation can compare spiking frequencies by a simple spiking counter.

The spiking multiplication and addition operation and the spiking accumulation operation implement the superposition of the spiking information by adopting the analog current superposition principle, on the basis of mapping the weight and the bias of the artificial neuron based on the MP model to the synaptic strength and the synaptic delay of the neuron based on the LIF model neuron, respectively. FIG. 6 illustrates more details of an implementation process of the spiking multiplication and addition operation or the spiking accumulation operations.

As illustrated in FIG. 6, when the spiking neuron receives an output signal of an upper-layer network, the spiking neuron determines whether the signal is the spiking information or the pixel-level data. If the signal is the pixel-level data, it is needed to complete spiking converting and encoding (spiking information converting and encoding \textcircled{1}); otherwise, the superposition of the analog current is performed in accordance with Formula (3). The superposition of the analog current follows the mapping relations of the synaptic strength and the synaptic delay. The superimposed analog current performing the spiking converting and encoding again on a charging and discharging process of membrane capacity (the spiking information converting and encoding \textcircled{2}) can characterize multiplication and addition or accumulation of the spiking information. The accumulation operation can be understood as a special case of the multiplication and addition operation (the weighting factor is 1).

Further, a method for implementing training of a fused network based on an equivalent convolutional neural network further includes implementing a conversion of a learning and training result of the equivalent convolutional neural network and the learning and training result of the fused network of the convolutional neural network and the spiking neural network by establishing a corresponding relation between the equivalent convolutional neural network and the fused neural network. The corresponding relation between the equivalent convolutional neural network and the fused neural network further includes a mapping relation between the equivalent convolutional neural network and the fused network in terms of a network layer structure, a weight and a bias, and an activation function, etc.

Specifically, learning and training of the fused network of the convolutional neural network and the spiking neural network adopts a method of training the fused network based on the equivalent convolutional neural network. The equivalent convolutional neural network and the fused network respectively establish a one-to-one corresponding relation in terms of the network layer structure, the weight and the bias, and the activation function. FIG. 6 illustrates more details of the learning and training of the fused network of the convolutional neural network and the spiking neural network.

As illustrated in FIG. 6, the equivalent convolutional neural network is generated based on a structure parameter of the fused network of the convolutional neural network and the spiking neural network. The activation function of the equivalent convolutional neural network is replaced or adjusted based on Formula (1) or Formula (2). Convergence of a training algorithm is monitored during a back propagation calculation process until an appropriate equivalent activation function is selected. After a training result of the equivalent convolutional neural network meets a requirement, a corresponding network parameter (such as the weight, the bias, etc.) is mapped based on the synaptic strength and the synaptic delay to obtain the training result of the fused network of the convolutional neural network and the spiking neural network.

In summary, compared with the related art, the fused network of the convolutional neural network and the spiking neural network of the present disclosure has the following advantages and beneficial effects.

(1) Compared with the conventional convolutional neural network, the fused network provided by the present disclosure can not only exert advantages of the convolutional neural network in ensuring the image recognition accuracy, but also give play to advantages of the spiking neural network in terms of low power consumption and low latency. In addition, the fused network makes full use of the sparsity of the spiking information in the spiking neural network structure part, which greatly reduces an amount of network operations and calculation delays, and is more in line with real-time requirements of practical applications of high-speed target recognition engineering.

(2) Compared with the conventional spiking neural network, the fused network provided by the present disclosure provides a method to implement image recognition on a basis of the spiking neural network. A spiking converting and encoding method, a spiking convolution operation method, a spiking pooling operation method, etc., involved in the fused network all have strong versatility and can be applied to any problems that may need to use the spiking neural network structure for feature extraction and classification, thereby solving a problem of using the spiking neural network to achieve the feature extraction and the accurate classification.

(3) The convolutional neural network part, the spiking converting and encoding part, the spiking neural network part, and the number of network layers in which the convolution operation or the pooling operation is completed involved in the fused network structure provided by the present disclosure can be added or deleted appropriately based on practical application tasks, can adapt to any scale of neural network structures, and have high flexibility and scalability.

(4) The mapping and replacement method between the artificial neuron based on the MP model and the spiking neuron based on the LIF model involved in the fused network provided by the present disclosure is simple and clear. In addition, since the training method of the fused network is borrowed from the training method of the conventional convolutional neural network, the mapping method of the synaptic strength and the synaptic delay is simple and feasible. The fused network provided by the present disclosure can be quickly deployed in practical engineering applications and has high practicability.

With the fusion structure of the convolutional neural network and the spiking neural network according to an embodiment of the present disclosure, the structure of the fused network is clear and the training algorithm of the fused network is simple. The fused network can not only exert advantages of the convolutional neural network in ensuring the image recognition accuracy, but also give play to advantages of the spiking neural network in terms of low power consumption and low delay. The fusion structure is tailorable and universal, with a simple implementation and moderate costs. In addition, the fusion structure can be quickly deployed to different practical engineering applications. In any related engineering projects that need to achieve the high-speed image recognition, the feature extraction and the accurate classification of the high-speed time-varying information can be implemented through designing the fused network.

The fusion method of the convolutional neural network and the spiking neural network according to an embodiment of the present disclosure will be described with reference to the accompanying drawings.

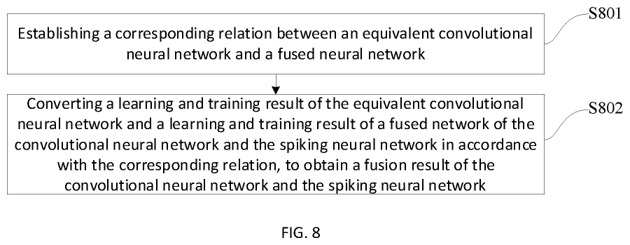

FIG. 8 is a flowchart of a fusion method of a convolutional neural network and a spiking neural network according to an embodiment of the present disclosure.

As illustrated in FIG. 8, the fusion method of the convolutional neural network and the spiking neural network includes the following steps.

In step S801, a corresponding relation is established between an equivalent convolutional neural network and a fused neural network.

In step S802, a learning and training result of the equivalent convolutional neural network and a learning and training result of a fused network of the convolutional neural network and the spiking neural network are converted in accordance with the corresponding relation to obtain a fusion result of the convolutional neural network and the spiking neural network.

Further, in an embodiment of the present disclosure, the corresponding relation between the equivalent convolutional neural network and the fused neural network includes the mapping relation between the network layer structure, the weight and the bias, and the activation function.

It should be noted that the above explanation of the embodiments of the fusion structure of the convolutional neural network and the spiking neural network is also applicable to the fusion method of the convolutional neural network and the spiking neural network according to the embodiment, and details thereof will be omitted here.

With the fusion method of the convolutional neural network and the spiking neural network according to an embodiment of the present disclosure, the structure of the fused network is clear and the training algorithm of the fused network is simple. The fused network can not only exert advantages of the convolutional neural network in ensuring the image recognition accuracy, but also give play to advantages of the spiking neural network in terms of low power consumption and low delay. The fusion structure is tailorable and universal, with a simple implementation and moderate costs. In addition, the fusion structure can be quickly deployed to different practical engineering applications. In any related engineering projects that need to achieve the high-speed image recognition, the feature extraction and the accurate classification of the high-speed time-varying information can be implemented through designing the fused network.

In addition, terms such as “first” and “second” are only used for purposes of description, and are not intended to indicate or imply relative importance, or to implicitly show the number of technical features indicated. Therefore, a feature defined with “first” and “second” may explicitly or implicitly includes one or more this feature. In the description of the present disclosure, “a plurality of” means at least two, such as two, three, etc., unless specified otherwise.

In the present disclosure, unless specified or limited otherwise, the first feature being “on” or “under” the second feature may refer to that the first feature and the second feature are in direct connection, or the first feature and the second feature are indirectly connected through an intermediary. In addition, the first feature being “on”, “above”, or “over” the second feature may refer to that the first feature is right above or diagonally above the second feature, or simply refer to that a horizontal height of the first feature is higher than that of the second feature. The first feature being “under” or “below” the second feature may refer to that the first feature is right below or diagonally below the second feature, or simply refer to that the horizontal height of the first feature is lower than that of the second feature.

In the description of the present disclosure, reference throughout this specification to “an embodiment”, “some embodiments”, “an example”, “a specific example” or “some examples”, etc., means that a particular feature, structure, material or characteristic described in conjunction with the embodiment or example is included in at least one embodiment or example of the present disclosure. Therefore, appearances of the phrases in various places throughout this specification are not necessarily referring to the same embodiment or example. In addition, the particular feature, structure, material or characteristic described can be combined in one or more embodiments or examples in any suitable manner. Without a contradiction, different embodiments or examples of the present disclosure and features of the different embodiments or examples can be combined by those skilled in the art.

Although the embodiments of the present disclosure have been shown and described above, it can be understood that the above embodiments are exemplary and should not be construed as limiting the present disclosure. Those skilled in the art can make changes, modifications, and alternatives to the above embodiments within the scope of the present disclosure.

What is claimed is:

1. A fusion structure of a convolutional neural network and a spiking neural network, comprising:
a convolutional neural network structure comprising an input layer, a convolutional layer and a pooling layer, wherein the input layer is configured to receive pixel-level image data, the convolutional layer is configured to perform a convolution operation, and the pooling layer is configured to perform a pooling operation;
a spiking converting and encoding structure comprising a spiking converting neuron and a configurable spiking encoder, wherein the spiking converting neuron is configured to convert the pixel-level image data into spiking information based on a preset encoding form, and the configurable spiking encoder is configured to set the spiking converting and encoding structure into time encoding or frequency encoding; and
a spiking neural network structure comprising a spiking convolutional layer, a spiking pooling layer, and a spiking output layer, wherein the spiking convolutional layer and the spiking pooling layer are respectively configured to perform a spiking convolution operation and a spiking pooling operation on the spiking information to obtain an operation result, and the spiking output layer is configured to output the operation result.

2. The fusion structure of the convolutional neural network and the spiking neural network according to claim 1, wherein the spiking converting neuron is further configured to map the pixel-level image data into an analog current in accordance with a conversion of a spiking firing rate and obtain the spiking information based on the analog current.

3. The fusion structure of the convolutional neural network and the spiking neural network according to claim 2, wherein a corresponding relation between the spiking firing rate and the analog current is:
$$Rate = \frac{1}{{t}_{ref} - {τ}_{RC} ln ( \frac{V ( {t}_{1} ) - I}{V ( {t}_{0} ) - I} )} ,$$
where Rate represents the spiking firing rate, t_{ref} represents a length of a neural refractory period, τ_{RC} represents a time constant determined based on a membrane resistance and a membrane capacitance, V(t₀) and V(t₁) represent membrane voltages at t₀ and t₁, respectively, and/represents the analog current.

4. The fusion structure of the convolutional neural network and the spiking neural network according to claim 1, wherein the spiking convolution operation further comprises:
a pixel-level convolutional kernel generating a spiking convolutional kernel in accordance with mapping relations of a synaptic strength and a synaptic delay of a neuron based on an LIF model, and generating a spiking convolution feature map in accordance with the spiking convolutional kernel and the spiking information through a spiking multiplication and addition operation.

5. The fusion structure of the convolutional neural network and the spiking neural network according to claim 4, wherein the spiking pooling operation further comprises:
a pixel-level pooling window generating a spiking pooling window based on the mapping relations of the synaptic strength and the synaptic delay, and generating a spiking pooling feature map in accordance with the spiking pooling window and the spiking information through a spiking accumulation operation.

6. The fusion structure of the convolutional neural network and the spiking neural network according to claim 5, wherein the mapping relations of the synaptic strength and the synaptic delay further comprise:
the pixel-level convolutional kernel and the pixel-level pooling window mapping a weight and a bias of an artificial neuron based on an MP model to the synaptic strength and the synaptic delay of the neuron based on the LIF model, respectively.

7. The fusion structure of the convolutional neural network and the spiking neural network according to claim 6, wherein the mapping relations of the synaptic strength and the synaptic delay further comprise:
the spiking information being superposed by adopting an analog current superposition principle, on a basis of mapping the weight and the bias of the artificial neuron based on the MP model to the synaptic strength and the synaptic delay of the neuron based on the LIF model, respectively.

8. The fusion structure of the convolutional neural network and the spiking neural network according to claim 7, wherein the spiking accumulation operation further comprises:
the pixel-level convolutional kernel mapping the weight and the bias of the artificial neuron based on the MP model to the synaptic strength and the synaptic delay of the neuron based on the LIF model.

9. A fusion method of a convolutional neural network and a spiking neural network, applied in the fusion structure of the convolutional neural network and the spiking neural network according to claim 1, the fusion method comprising the following steps of:
establishing a corresponding relation between an equivalent convolutional neural network and a fused neural network; and
converting a learning and training result of the equivalent convolutional neural network and a learning and training result of a fused network of the convolutional neural network and the spiking neural network in accordance with the corresponding relation, to obtain a fusion result of the convolutional neural network and the spiking neural network.

10. The fusion method of the convolutional neural network and the spiking neural network according to claim 9, wherein the corresponding relation between the equivalent convolutional neural network and the fused neural network comprises a mapping relation between a network layer structure, a weight and a bias, and an activation function.
